(19) United States
(12) Patent Application Publication
(10) Pub. No.: US 2008/0162477 A1
(43) Pub. Date: Jul. 3, 2008

(54) METHOD, APPARATUS, SYSTEM, AND COMPUTER READABLE MEDIUM FOR MEDIA DISTRIBUTION

(76) Inventor: Benjamin Rodefer, Corrales, NM (US)

Correspondence Address: SUGHRUE MION, PLLC, 2100 PENNSYLVANIA AVENUE, N.W., SUITE 800, WASHINGTON, DC, 20037, US

(21) Appl. No.: 11/960,339

(22) Filed: Dec. 19, 2007

Related U.S. Application Data
(60) Provisional application No. 60/876,390, filed on Dec. 20, 2006.

(51) Int. Cl. G06F 17/30

(52) U.S. Cl. 707/6; 707/E17.014

(57) ABSTRACT

Distributing media items that allows a user a wider variety of options, and greater simplicity in creation and management of queues used to distribute the items. The method including inputting a search criteria for at least one queue, searching a library of items for items matching the search criteria, generating a list of search results based on the search, creating the at least one queue by automatically populating the at least one queue with the list of search results, and distributing an item in the at least one queue.

This application claims the benefit of U.S. Provisional Patent Application No. 60/876,390 titled “Patent relating to media distribution” filed on Dec. 20, 2006, the disclosure of which is incorporated by reference in its entirety.

### BACKGROUND OF THE INVENTION

1. Field of the Invention

Methods, apparatuses, systems, and computer readable mediums consistent with the present invention relate to creating, managing, organizing and providing queues or lists of items, such as digital media.

2. Background of Related Art

Existing methods of delivering media, such as those employed by the popular online DVD rental service Netflix, require that a user creates a queue or list of movies they would like to see, which are systematically distributed and delivered to the user in the order of the user created queue or list as previously viewed movies are returned. However, in these existing techniques, the user is required to manually manage the queue or list of movies, which can be cumbersome to the user. The user is also restricted in the options the user has in creating the queue or list of movies to see next. That is, in conventional techniques, the user simply selects a movie that is desirable and places it into this list or queue.

### SUMMARY OF THE INVENTION

Embodiments of the present invention help overcome the above-described disadvantages and address other problems. Any given particular embodiment of the present invention may or may not overcome any one or more of the discussed disadvantages.

What is proposed is creating, managing, organizing and providing queues or lists of items, such as digital media, awaiting delivery more easily. For example, according to an aspect of the present invention, a user is allowed a wider variety of options, and greater simplicity in both queue creation and management. According to another aspect of the present invention, the user may create multiple different queues for the distribution.

According to another aspect of the present invention, there is provided a method of distributing items, the method comprising input a search criteria for at least one queue; searching a library of items for at least one item matching the search criteria; generating a list of search results based on said searching; automatically creating the at least one queue by populating the at least one queue with the list of search results; and distributing an item in the at least one queue.

According to another aspect of the present invention, there is provided a system for distributing items, the system comprising a client which provides a search criteria input for creation of at least one queue identifying items for distribution; and a storage area storing a library of items; and a server which executes operations comprising receiving the search criteria input by the client, searching the library of items for at least one item matching the search criteria, generating a list of search results, creating the at least one queue by populating the at least one queue with the list of search results, and distributing an item in the at least one queue.

According to another aspect of the present invention, there is provided an apparatus for distributing items, the apparatus comprising: a memory unit which stores a library of items, an input unit which receives a search criteria for at least one queue, a processing unit which searches the library of items for at least one item matching the search criteria, generates a list of search results based on the search, creates the at least one queue by automatically populating the at least one queue with the list of search results, and an output unit which distributes an item from the at least one queue.

According to another aspect of the present invention, there is provided a computer-readable medium having recorded thereon computer-readable instructions for distributing items, the instructions comprising: input a search criteria for at least one queue, searching a library of items for items matching the search criteria, generating a list of search results based on the searching, creating the at least one queue by populating the at least one queue with the list of search results, and distributing an item from the at least one queue.

According to another aspect of the present invention, there is provided a device for distributing items, the device comprising: means for inputting a search criteria for at least one queue, means for searching a library of items for items matching the search criteria, means for generating a list of search results based on the searching, means for creating the at least one queue by automatically populating the at least one queue with the list of search results, and means for distributing an item in the at least one queue.

### BRIEF DESCRIPTION OF THE DRAWINGS

The drawing figures depict, in highly simplified schematic form, exemplary embodiments reflecting the principles of the invention. Many items and details that will be readily understood by one familiar with this field have been omitted so as to avoid obscuring the invention. Aspects of the illustrative, non-limiting embodiments of the present invention will become more apparent by describing in detail embodiments thereof with reference to the attached drawings in which:

FIG. 1 is a block diagram of a system for media distribution according to an exemplary embodiment of the present invention.

FIG. 2 is a flow chart illustrating a creation of a queue according to an exemplary embodiment of the present invention.

FIG. 3A is a flow chart illustrating updating a queue in response to a new record in a media library according to an exemplary embodiment of the present invention.

FIG. 3B is a flow chart illustrating updating a queue in response to changing an existing record in a media library according to an exemplary embodiment of the present invention.

FIG. 3C is a flow chart illustrating updating a queue in response to removing an existing record in a media library according to an exemplary embodiment of the present invention.

FIG. 4 is a flow chart illustrating selecting a media item from a queue for distribution according to an exemplary embodiment of the present invention.

FIG. 5 is a flow chart illustrating selecting a media item from a queue for distribution according to another exemplary embodiment of the present invention.

FIG. 6A is a flow chart illustrating configuring a queue reference list according to an exemplary embodiment of the present invention.

FIG. 6B is a flow chart illustrating distributing media items according to an exemplary embodiment of the present invention.

FIG. 7 is a flow chart illustrating tracking and determining queue preferences according to an exemplary embodiment of the present invention.

FIG. 8 is a block diagram illustrating a media distribution system according to an exemplary embodiment of the present invention.

### DETAILED DESCRIPTION OF EXEMPLARY EMBODIMENTS OF THE PRESENT INVENTION

Exemplary embodiments of the present invention will now be described in greater detail with reference to the accompanying drawings. The invention will now be taught using various exemplary embodiments. Although the exemplary embodiments are described in detail, it will be appreciated that the invention is not limited to just these embodiments, but has a scope that is significantly broader. The appended claims should be consulted to determine the true scope of the invention.

In the exemplary embodiments of the present invention, the following terms are defined below. These definitions are provided to merely define the terms used to describe non-limiting, exemplary embodiments of the present invention. It will be appreciated that the following definitions are not limitative of any claims in any way.

A media library is a dataset of records, with each record representing a media item, which can be distributed to a user or a client. Each record may contain primary data used to identify the media item, such as name, author, date of publication/creation, etc. In addition, each record may have a broad collection of supplementary data, such as genre, style, country of origin, awards, etc, which may serve to group or find common media items.

A queue represents an ordered list of items from the media library intended for distribution. Once a media item has been distributed to a user or client, it may be removed from the specific queue. There may be many queues, either shared across multiple users of a system or owned by a specific user, and each media item can appear in multiple queues. The order of a queue can be random, based on specific criteria (e.g., alphabetically according to name or chronologically according to date of creation of the media), or based on a user-determined order (i.e., the user sets the desired order for the media). By default, a queue may be ordered according to the time an item is added to the queue commonly known as FIFO (first in, first out) i.e., the item added first would be the first one distributed.

Each user of the system may have a user account that may be represented by a record in a dataset, and can access the system after authenticating him/herself in someway (usually by username and password). Each user account may ‘own’ one or more queues. Depending on the configuration of the user account, media items will be distributed (either by physical or digital delivery) to that user based on their defined queues. Distribution involves reading user configuration to identify which queue should be used next, then taking the next item from the top of the ordered queue. Distribution can be performed at a set time interval (for example, once a week or once a month) or can occur when a previously distributed item is returned.

In an exemplary, non-limiting embodiment, the user may simply specify predefined criteria and the queue will be automatically created. Furthermore, various queues for various different criteria may be specified and the distribution may vary from these multiple queues based on an algorithm, as explained in greater detailed in exemplary embodiments below.

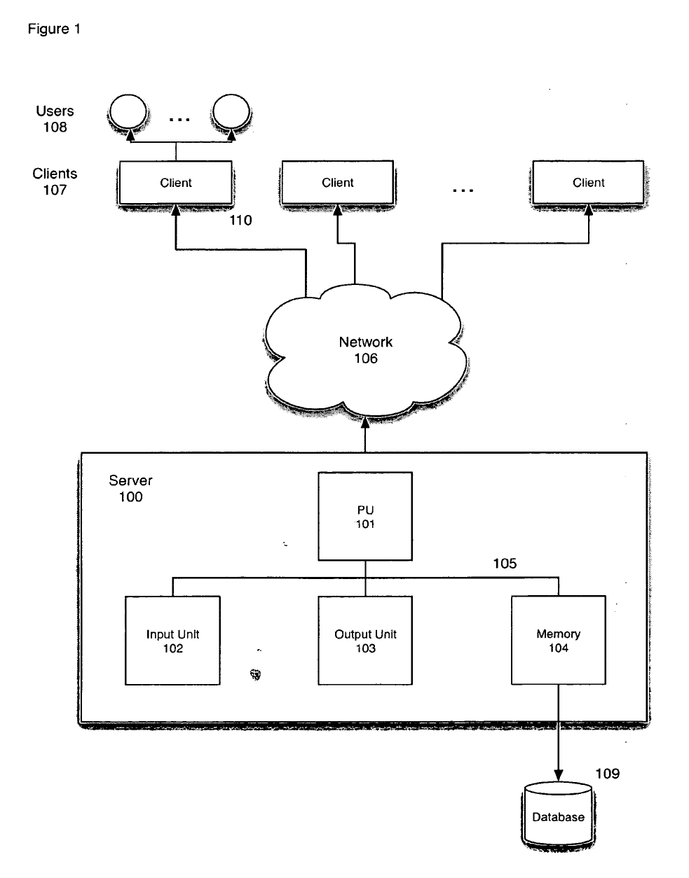

FIG. 1 depicts a system for media distribution according to an exemplary embodiment of the present invention. As illustrated in FIG. 1, multiple Clients 107 (1 . . . X) may be connected to a Server 100 through a Network 106. Client devices 107 (1 . . . X) may be personal computers, mobile telephones with Internet access capability, notebook computers and the like. A Database 109 is connected to the sever 100, and holds data such as the media library or information related to accounts of various users, such as the queues ‘owned’ by each user account, or preferences of each user. The Server 100 comprises a Processing Unit (PU) 101 that is connected to Input Unit 102, Output Unit 103, and Memory 104, through Bus 105. Users 108 provide input to one of the Clients 107, such as Client 110, which is then directed to the Input Unit 102 of the Server 100 via Network 106. The Network 106 may be any network which facilitates communication between the Client 110 and Server 100, such as a Local Area Network, a Cellular Network, or the Internet. Users 108 may provide the input via input device such as a computer keyboard or mouse. The PU 101 processes the input and provided by Clients 110, and executes an appropriate task (such as creating a queue for the user) if applicable based on the input provided. The Output Unit 103 outputs information to the Client 110, such as a confirmation that the input is received, or the result of an executed task. The Client 110 may then display this information to the user on a display device of the Client 110, such as an LCD display. The Output Unit 103 may also output media items for distribution. As an alternative exemplary embodiment, the Client 110 may be integrated with the Server 100 in one device. The Database 109 may be the memory if this single device.

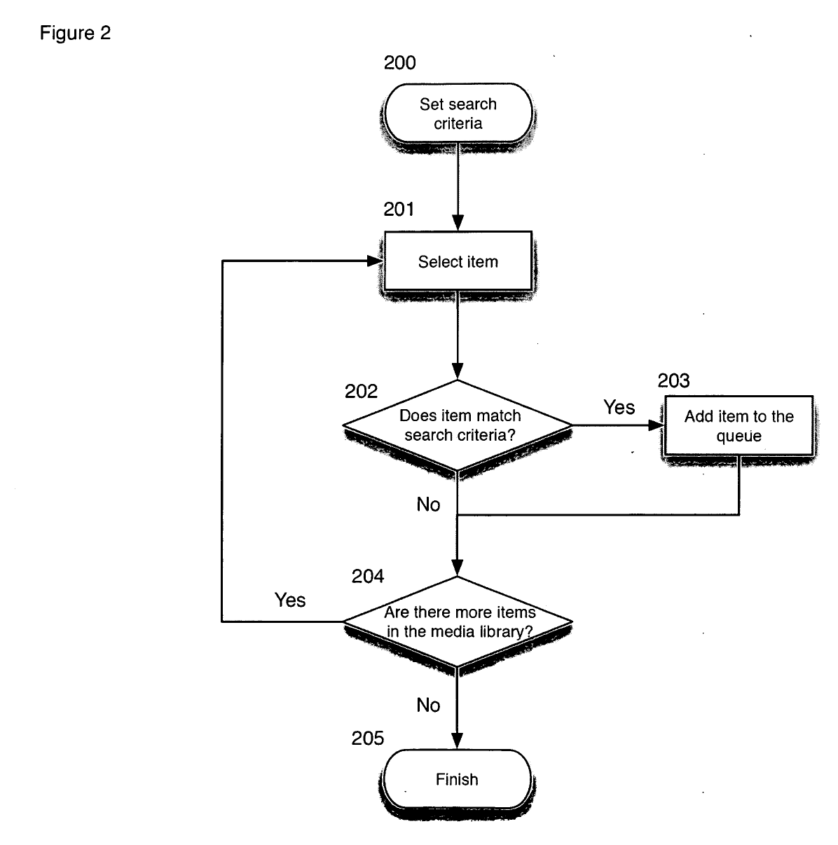

FIG. 2 depicts a process for the creation of a queue, by selecting a subset of the media library through one or more limiting search criteria according to an exemplary embodiment of the present invention. The search criteria is input by a user in operation 200. For example, the user may provide search criteria specifying media items of the genre “comedy” that were created prior to “1960”, or specifying media items by the author “Hemingway”, or artist “Pink Floyd” etc. When the search criteria exists (i.e. previously input by a user), the first or next item from the media library is selected in operation 201. That is, if there has not been a previous selection, then the first item in the media library is selected. Otherwise, the next media item in the media library subsequent to the previous selected media item is selected. The media item is checked against the search criteria in operation 202. If the media item matches all criteria specified in operation 202, then it will be added to the queue in operation 203. After processing the record, it is checked if there is another item in media library in operation 204. If there exists another item in the media library the next media item will be selected in operation 201 and the process will be repeated. Once all media items have been selected in this manner, the queue will be created and the creation process will end in operation 205.

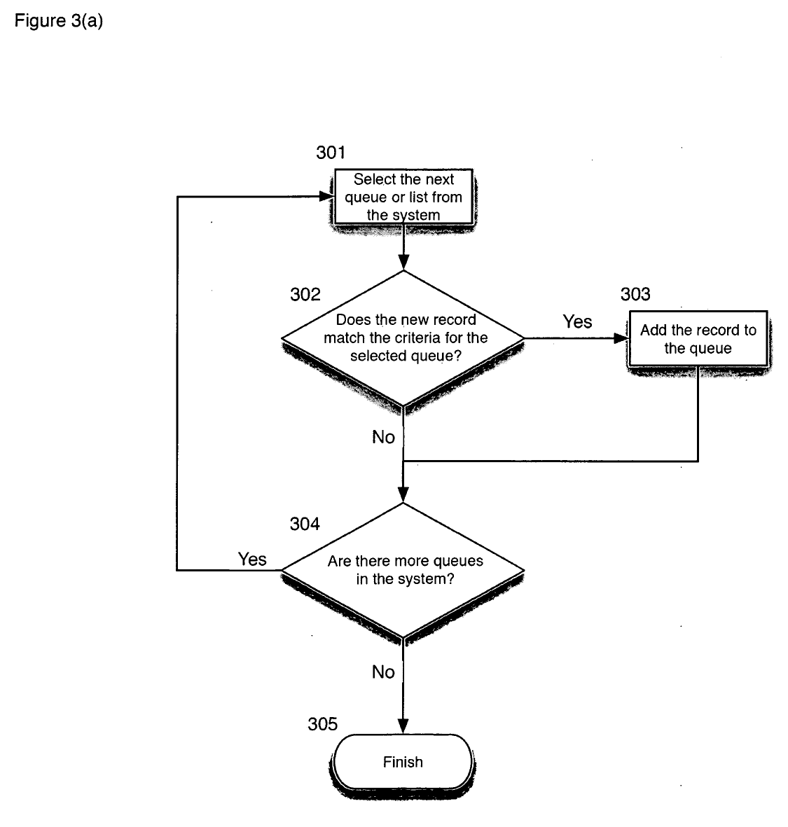

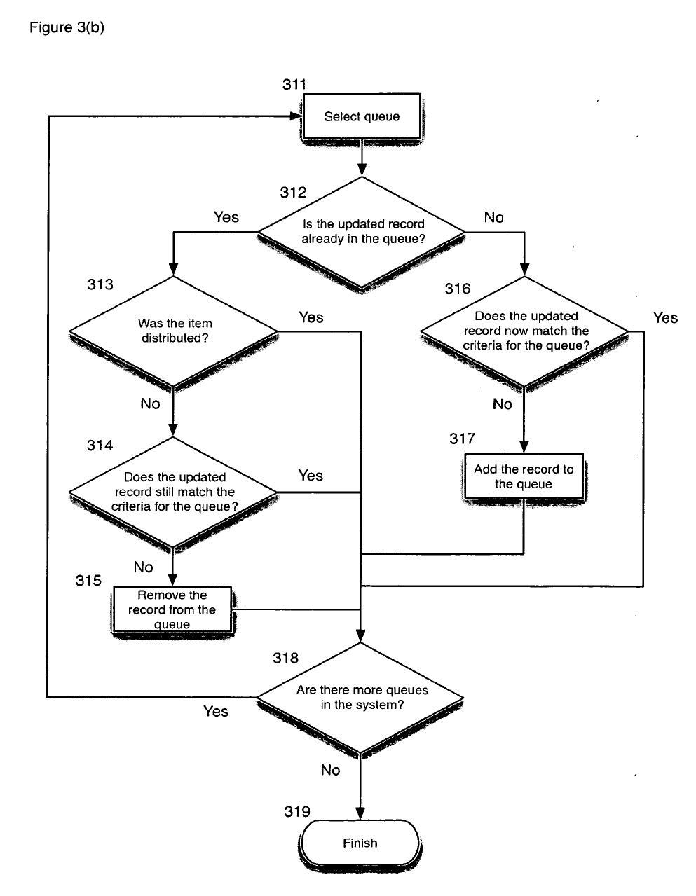

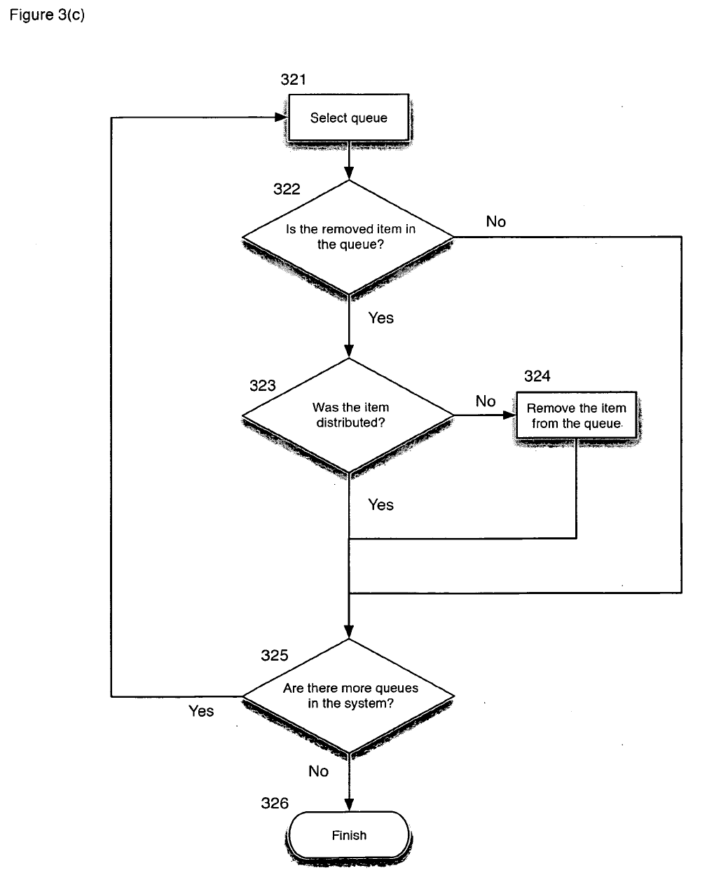

FIG. 3A-3C depict processes for updating a dynamic queue according to exemplary embodiments of the present invention. When a queue is created by a predetermined search criteria (e.g. input by a user), the user can optionally define the as dynamic, meaning that whenever new items in the media library match the defining criteria, they will be automatically added to the queue (keeping it up to date) as opposed to a static queue, which once created based on the search criteria, will not be automatically modified to reflect changes in the media library. The exemplary processes depicted in FIGS. 3A-3C are triggered whenever a record in the media library is updated (added, changed or deleted, as described in these FIGS. 3A-3C, respectively).

FIG. 3A depicts a process of updating a queue when a new media item is added to the media library. The new media item must be checked against the original search criteria used for each queue in the system, that is, for each queue of each user. First, in operation 301, a first or next queue stored queue is selected. That is, if there has not been a previous selection, then the first stored queue is selected. Otherwise, the next queue subsequent to the previous selected queue is selected. The new media item that was added is checked if it matches the original search criteria used for the selected queue in operation 302. If the record matches the search criteria, then it will be added to the queue in operation 303. Next, a check s performed to determine if there are more queues that need to be scheduled in operation 304. If there are more queues, the next queue is selected in operation 301. In other words, the process will be repeated. Once all queues have been processed in this manner, the processing will terminate in operation 305.

FIG. 3B depicts a process of updating queues when an existing media item in the media library modified, according to an exemplary embodiment of the present invention. In this process, a first or next stored queue is selected in operation 311. That is, if there is no previous selection, then the first queue is selected. Otherwise, the next stored queue in the system subsequent to the previous selected queue is selected. It is then evaluated whether the updated media item in the media library is in the selected queue in operation 312.

If in operation 312, it is determined that the media item is already in the queue, then it is first checked if the specific media item has already been distributed, in operation 313. If the media item has already been distributed, then it can no longer be added or removed from the queue and processing of the specific queue is complete. The process then proceeds to operation 318, described below. Otherwise, if it is determined that the item has not been distributed in operation 313, then, in operation 314, it is determined if the item still matches the original search criteria used for the selected queue. If the item no longer matches the criteria, then it is removed from the queue in operation 315 and the process will proceed to operation 318. In operation 318, it is checked if there are more stored queues that need to be checked, and if so, the process will proceed to operation 311 where the next queue in the system is selected and the process is repeated. Otherwise the process will end at operation 319.

If, on the other hand, it is determined that the modified media item is not in the current queue in operation 312, then the media item will be checked to see if it matches the original search criteria used for the selected queue, in operation 316. If the media item matches the search criteria, then it will be added to the queue in operation 317. Next, it is determined if there are more stored queues that need to be checked in operation 318, and if so then the process will proceed to operation 311 where the next stored queue is selected and the process is repeated. If the updated media item does not match the search criteria, then the process proceeds to operation 318. Once all queues have been processed in this manner, the processing will terminate in operation 319.

FIG. 3C depicts a process of updating a queue when an existing media item is removed from the media library according to an exemplary embodiment of the present invention. First, in operation 321, a first or next queue is selected from the system. That is, if there has not been a previous selection, then the first stored queue is selected. Otherwise, the stored next queue subsequent to the previous selected queue is selected. It is then verified, in operation 322, whether the media item that was removed is in the selected queue, and if so, it is checked if the specific media item has already been distributed, in operation 323. If the item has been distributed, then it can no longer be added or removed from the queue and processing of the selected queue is complete. Otherwise, if the item has not been distributed, then it will be removed from the queue in operation 324. Next, in operation 325, it is checked if there are more stored queues that need to be checked, and if so, the process will proceed to operation 321 where the next stored queue is selected and the process is repeated. Once all queues have been processed in this manner, the process will terminate in operation 326.

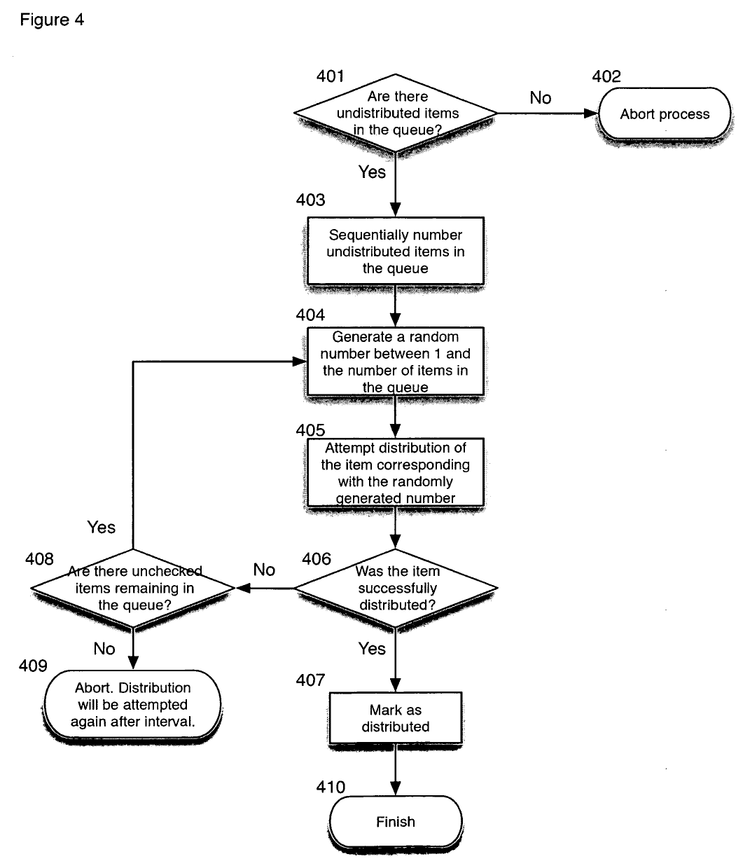

FIG. 4 depicts a process of randomly selecting a media item from a queue for distribution. In operation 401, it is determined if there are undistributed media items in a selected queue. If there are no undistributed items, the process is aborted in operation 402. Otherwise, the process proceeds to operation 403, where each undistributed media item in the queue is assigned a number from ‘1’ incrementally until ‘n’, n being the number of items in the queue. For example, first, second, and third items maybe numbered 1, 2, 3, respectively, and the nth item is numbered n. The process then generates a random number between one and n (the number of items in the queue inclusive) in operation 404. The undistributed item in the queue corresponding to the generated random number is then distributed, either physically or digitally in operation 405. Next, in operation 406, it is verified if the item was successfully distributed, and if so, then the item is marked as distributed for the queue, in operation 407 and the process completes successfully at operation 410. If it is determined that the media item was not successfully distributed in operation 406, then it is checked if there remains other undistributed items in the queue 408, and if so, another random number will be generated at operation 404 and the process repeats. If there are no other undistributed items in the queue, then the selection process will fail and proceed to operation 409, where distribution will be attempted again after a short interval.

In an alternative exemplary embodiment of the present invention, instead of an item being marked as being distributed, a distributed item is removed from the queue it is distributed from. For example, operation 407 of FIG. 4 may instead comprise removing the distributed item from the queue, and operation 401 of FIG. 4 may check if there exists any items in the queue (since any item in the queue would be an undistributed item).

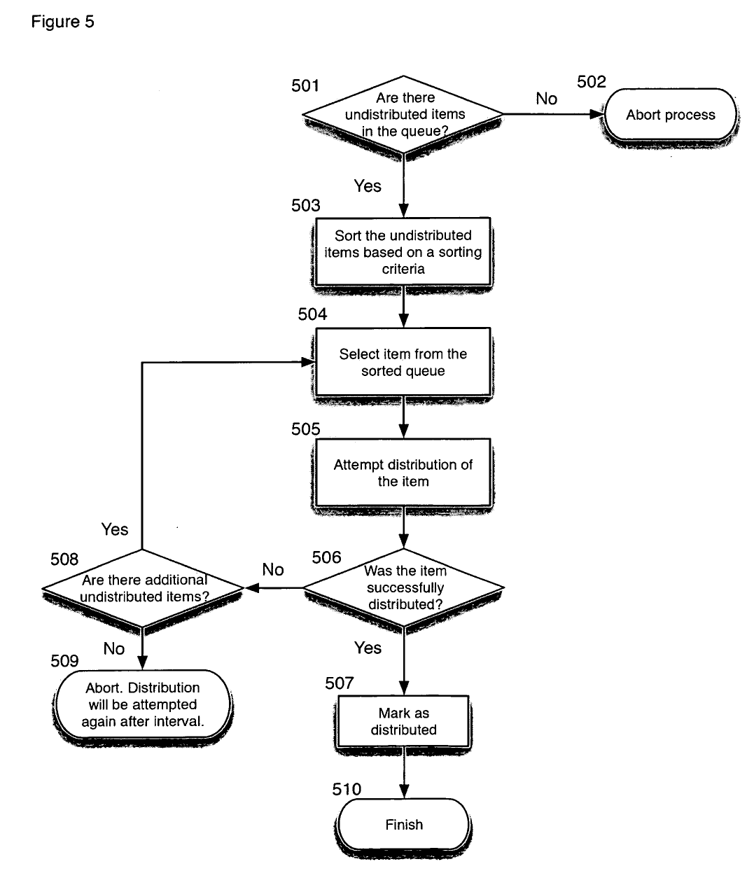

FIG. 5 depicts selecting an item from a queue for distribution based on specific sorting criteria according to an exemplary embodiment of the present invention. A selected queue is first sorted by a sorting criteria (e.g., chronologically by creation or alphabetically by name), and then the media item at the top of the queue is distributed. In addition to sorting based on information from the media library, the process can also use externally defined data, such as prioritization specified by the user (i.e., a custom determined order). First, at operation 501, it is determined if there are undistributed items in the selected queue. If there are no undistributed items in the queue, the process is aborted at operation 502. If there are undistributed items in the queue, then all undistributed items in the queue are sorted based on the sorting criteria in operation 503. Then the first or next item from the sorted queue is selected at operation 504 and is then distributed, either physically or digitally. That is, if there has not been a previous selection, then the first media item in the sorted queue is selected. Otherwise, the next media item in the sorted queue subsequent to the previous selected media item is selected. If the item is determined to have been successfully distributed at operation 506, then the item is marked as distributed for the queue in operation 507 and the process completes successfully in operation 508. If the item is determined to have not been successfully distributed at operation 506, then, it is checked if there are additional undistributed media items in the sorted queue at operation 508, and if so, the process proceeds to operation 504 where the next media item is selected and the process repeats. If there are no other undistributed items in the queue, then the selection process will fail and proceed to operation 509 where distribution will be attempted again after a short interval of time.

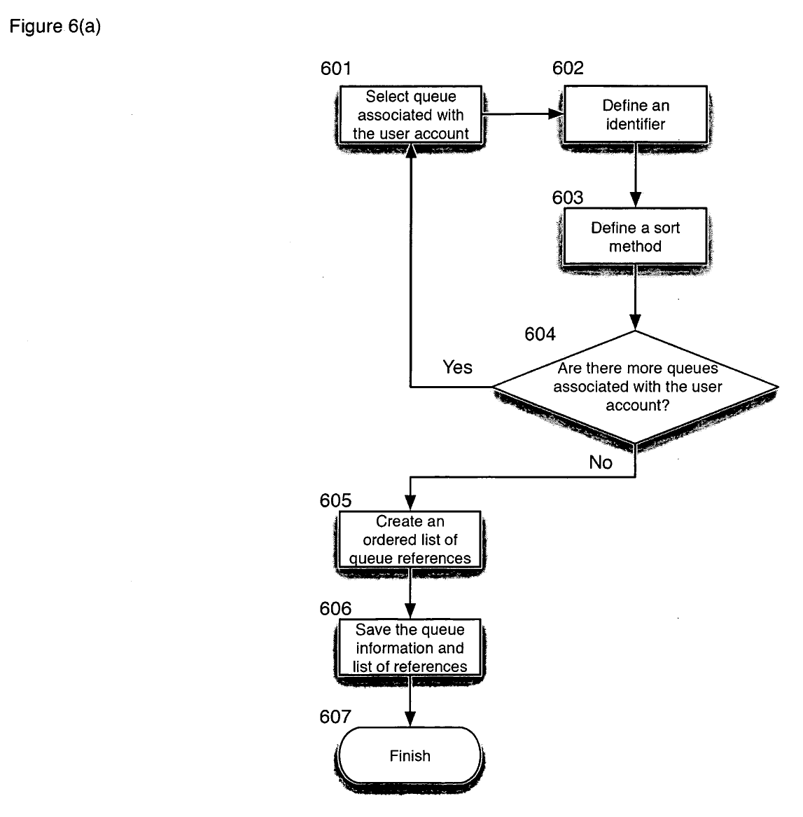

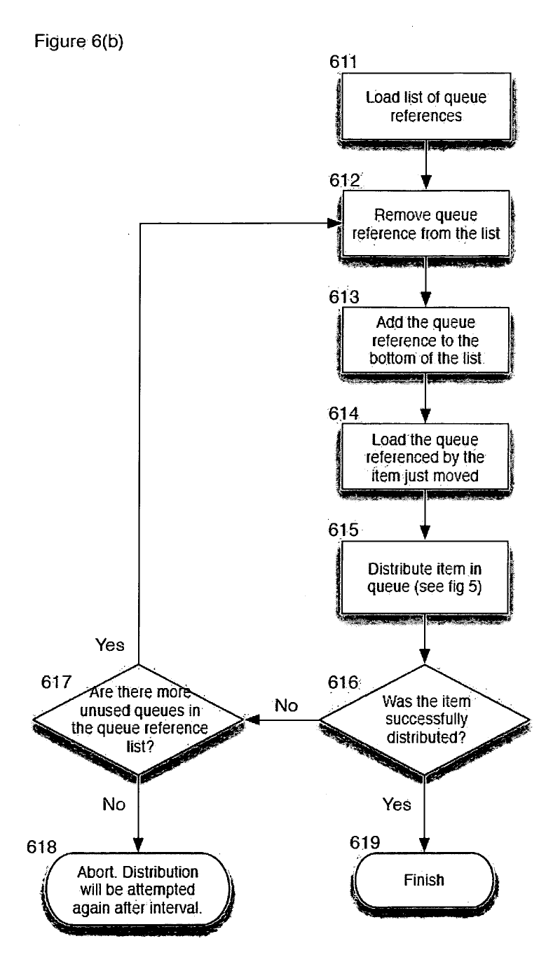

FIGS. 6A and 6B depict configuring queue references and distributing media based on multiple queues, either created by a specific user or preexisting on the system according to exemplary embodiments of the present invention. The process involves the user first configuring a set of queues (providing each queue a name and a sorting criteria), and then making a queue reference list that references the queues. Each queue can be referenced zero or more times in the queue reference list. The list will then be a guide for the distribution order of media. When distributing a media item, the process will take the first queue reference from the list, and based on the sorting criteria for the selected queue, a media item will be selected to be distributed (see FIG. 5). This method achieves a rotating, prioritized read order, so that a user can control the order and number of media items to be sent from each queue. The number of times a reference to a particular queue appears on the queue reference list determines how many times the user will receive a media item from that queue per rotation. FIG. 6A depicts a process for a user to configure the queue reference list, and FIG. 6B depicts a process for the actual sending of the media items.

FIG. 6A depicts a process for configuring the queue reference list. Before the process begins, a user first authenticates him or her self (usually by a user name and password). In operation 601, a first or next queue associated with the user account of the authenticated user is selected. In operation 602, the user defines an identifier for the selected queue. Then, in operation 603, the user defines a sort criteria for the selected queue. Next, in operation 604, it is checked if there are more queues associated with the user account, and if so, the process proceeds to operation 601 where the next queue associated with the user account is selected and the process repeats. The identifier defined by the user is used to identify the selected queue. The sorting criteria defined by the user can be one of many different ways for sorting the queue. The sorting criteria determines the order that media items from the queue are distributed (see FIG. 5 for details). Example sorting criteria include random, user-defined order, alphabetically by title, chronologically by creation date, and chronologically by date of addition to the queue, date of release, and so on. If, at operation 604, it is determined that there are no more queues associated with the user account, then the user creates an ordered queue reference list at operation 605. A reference to each queue can appear zero or more times on the queue reference list. The list serves as a guide for which queue to distribute from next when distributing media items (see FIG. 6B for details). Once the queue that is referenced by the top-most/first queue reference in the queue reference list, has been used (i.e. an item is distributed from the queue), the associated queue reference is rotated to the bottom of the queue reference list. The defined identifier and sorting criteria for each queue associated with the user account, along with the created queue reference list is then saved and associated with the user's account at operation 606, and the process completes at operation 607.

FIG. 6B depicts a process for distributing a media item to a user where there are multiple queues according to an exemplary embodiment of the present invention. First, the saved queue reference list associated with a specific user, is loaded in operation 611. The first queue reference of the queue reference list is removed in operation 612 and added to the bottom of the list in operation 613. Then, in operation 614, the queue that is referenced by the queue reference moved in operations 612 and 613 is loaded. The process then attempts, in operation 615, to distribute an item from the loaded queue, using the process depicted in FIG. 5. If at operation 616 it is determined that the distribution fails, for example, due to the loaded queue being empty and if at operation 617 it is determined that there are still unused queues referenced in the queue reference list, then the process proceeds to operation 612 and repeats with a new queue reference at the top of the list. If at operation 616 it is determined that distribution fails and if at operation 617, it is determined that there are no more unused queues items in the queue reference list, then the process proceeds to operation 618 where distribution is aborted and will be tried again later. Finally, if at operation 616 it is determined that distribution is successful, then the process will terminate successfully at operation 619.

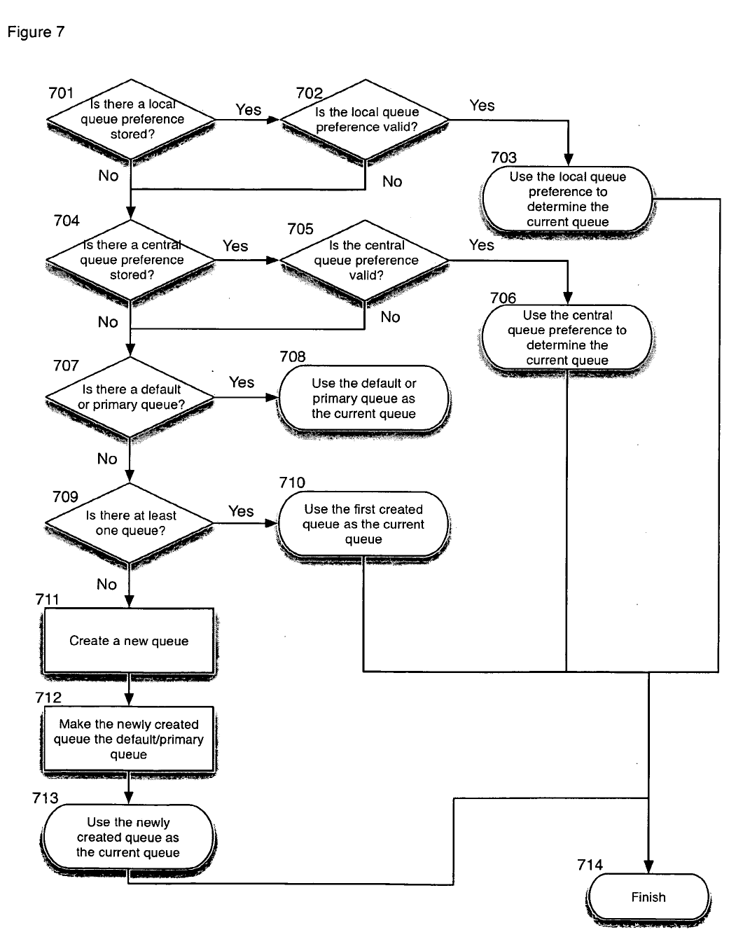

FIG. 7 depicts tracking and determining a queue preference according to an exemplary embodiment of the present invention. Since a user account may have multiple queues associated with it and more than one person may be actively using that account, a user can indicate a preference regarding which queue should be their primary queue. Queue preference can either be stored locally on a computer being used to access the service (e.g., an internet cookie) or can be stored centrally on the computer running the service. If stored centrally, the preference would be linked with an identifier (either a unique ID number, an IP address or another authentication code). The depicted process utilizes both local and central storage methods, with the local one taking precedence.

When an authenticated user first accesses the service, the program checks for a local queue preference in operation 701, usually stored as a cookie in the web browser of a client. If such a queue preference is found, then the queue preference is confirmed to reference a valid queue that is associated with the currently authenticated user account in operation 702. If the queue reference is valid, then the locally referenced queue preference is used to determine the current queue in operation 703.

If there is no local queue preference or if the local queue preference is not valid, the process will check for a centrally stored queue preference in operation 704 by searching for a queue preference associated with some identifier (IP address, session ID, or based on stored information associated with the user account). If such a queue preference is found, then the queue preference is confirmed to reference a valid queue that is associated with the currently authenticated user account in operation 705. If the queue reference is valid, then the centrally referenced queue preference is used to determine the current queue in operation 706.

If there is no central queue preference or if the queue preference is not valid, then the process will check for a default or primary queue in operation 707. If there is a default or primary queue associated with the current account, then the default or primary queue is used as current queue in operation 708.

Finally, if there is no default or primary queue, then the process checks that there is at least one queue in operation 709. If there is at least one queue, the first created queue is used as the current queue in operation 710. If there are no queues associated with the account, a new queue will be created in operation 711, which will automatically be marked as the default/primary queue in operation 712 and the newly created queue is used as the current queue in operation 713.

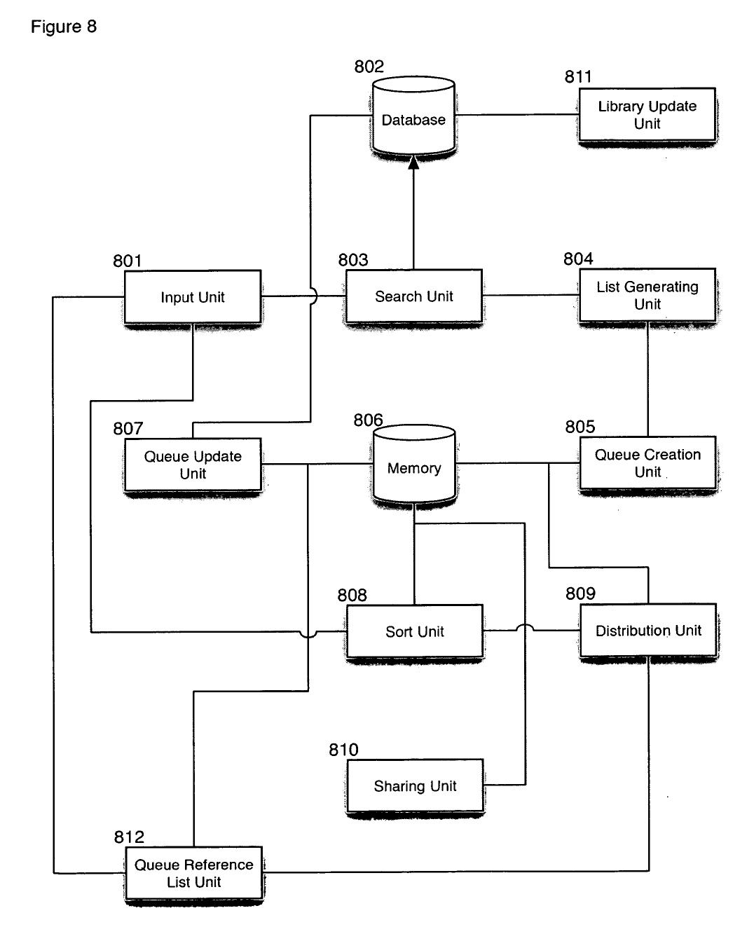

FIG. 8 depicts a block diagram of a media management and distribution system according to an exemplary embodiment of the present invention. Input Unit 801 provides input to the Search Unit 802 and Sort Unit 808. The input provided to the Search Unit 802 may be search criteria input used for creating a queue and the input provided to the Sort Unit 808 may be sort criteria input used for selecting items within a created queue. The Search Unit 802 searches a library of media items in database 803 according to the search criteria provided by the Input Unit 801. The Search Unit 802 may the provide the search results to the List Generating Unit 804 to generate a search result list of items from the library of items that match the provided search criteria. The Queue Creation Unit 805 would then create a queue based on the search result list and store the queue in Memory 806.

If Library Update Unit 811 updates an item in the library of items stored in Database 803, then the Queue Update Unit 807 updates the queue stored in Memory 806. If a new item is added to the library of items by the Library Update Unit 811, then the Queue Update Unit 807 checks if the new item matches the search criteria used to create the queue, and if so, adds the new item to the queue. If an existing item in the library of items is modified by the Library Update Unit 811, then the Queue Update Unit 807 checks if the item that was modified exists in the queue. If it exists in the queue, the Queue Update Unit 807 checks if the modified item still matches the search criteria used to create the queue, and if not, removes the modified item from the queue. If the item that was modified does not exist in the queue and the modified item matches the search criteria, then the modified item is added to the queue. If an item is removed from the library of items by the Library Update Unit 811, then the Queue Update Unit 807 removes the item from the queue, if it existed in the queue. The search criteria used to create the queue may be stored with the queue in the Memory 806 by the Queue Creation Unit 805, together with the queue, or somehow associated with the queue.

The Sort Unit 808 sorts the items in a queue according to the sort criteria provided by the Input Unit 801. The Sort Unit 808 may or may not save the sort back to Memory 806. The Distribution Unit 809 distributes an item in the queue from Memory 806, or from a sorted queue provided by the Sort Unit 808. Additionally, the Distribution Unit 809 may distribute an item from a queue based on a queue reference list provided by the Queue Reference List Unit 812. The Queue Reference List Unit 812 creates a queue reference list according to input provided by the Input Unit 801 and one or more queues stored in Memory 806. The Sharing Unit 810 allows a queue in Memory 806 to be shared between multiple users.

The various units in FIG. 8 may be implemented as software, hardware. For example, the Search Unit 802 my be implemented as a software algorithm, or implemented on hardware capable of performing the functions of the unit. Additionally, the unit may be implemented as a combination of hardware and software, such as hardware which contains firmware.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

The previous description of various embodiments and features of the present invention are provided to enable a person skilled in the art to make and use the present invention. Moreover, various modifications to these embodiments will be readily apparent to those skilled in the art, and the generic principles and specific examples defined herein may be applied to other embodiments without the use of inventive faculty. For example, some or all of the features of the different embodiments discussed above may be combined into a single embodiment. Conversely, some of the features of a single embodiment discussed above may be deleted from the embodiment. Therefore, the present invention is not intended to be limited to the embodiments described herein but is to be accorded the widest scope as defined by the limitations of the claims and equivalents thereof. It will be understood by those skilled in the art that various changes in form and details may be made therein without departing from the spirit and scope of the invention as defined by the appended claims.

What is claimed is:

1. A method of distributing items, the method comprising:
inputting a search criteria;
searching a library of items for at least one item matching the search criteria;
generating a list of search results based on said searching;
automatically creating at least one queue and populating the at least one queue with the list of search results; and
distributing an item in the at least one queue.

2. The method of claim 1, further comprising:
updating the at least one queue according to the search criteria when the library of items is modified,
wherein when a new item that matches the search criteria is added to the library of items, the item is added to the at least one queue,
wherein when an item in the library of items is modified and no longer matches the search criteria, the item is removed from the at least one queue, and
wherein when an item is removed from the library of items, the item is removed from the at least one queue.

3. The method of claim 1, wherein the distributing of the item from the at least one queue further comprises:
inputting a sort criteria for the at least one queue, wherein the items in the at least one queue are sorted according to the sort criteria, and
distributing the item in the at least one queue according to the order in which the items are sorted.

4. The method of claim 1, wherein the distributing of the item from the at least one queue further comprises:
assigning a sequential numerical value to each item in the at least one queue,
generating a random number that is within the assigned sequence of numerical values, and
distributing the item in the at least one queue which corresponds to the generated random number.

5. The method of claim 1, further comprising sharing the at least one queue between multiple users.

6. The method of claim 1, wherein the distributing of the item from the at least one queue further comprises:
creating a queue reference list that provides an ordered prioritization of two or more queues,
selecting a queue to distribute an item according to the queue reference list, and
distributing an item in the selected queue.

7. The method of claim 1, further comprising:
awaiting a distribution request to distribute the item in the at least one queue,
distributing at least one additional item in the at least one queue, and
removing the distributed item from the at least one queue.

8. The method of claim 1, wherein the distributing of the item from the at least one queue further comprises:
defining a distribution protocol, and
distributing the item according to the distribution protocol.

9. A system for distributing items, the system comprising:
a client which provides a search criteria input for creation of at least one queue identifying items for distribution; and
a storage area storing a library of items; and
a server which executes operations comprising:
receiving the search criteria input by the client,
searching the library of items for at least one item matching the search criteria,
generating a list of search results,
creating the at least one queue and populating the at least one queue with the list of search results, and
distributing an item in the at least one queue.

10. The system of claim 9, wherein the operations the server executes further comprise:
updating the at least one queue according to the search criteria when the library of items is modified,
wherein when a new item that matches the search criteria is added to the library of items, the item is added to the at least one queue,
wherein when an item in the library of items is modified and no longer matches the search criteria, the item is removed from the at least one queue, and
wherein when an item is removed from the library of items, the item is removed from the at least one queue.

11. The system of claim 9, wherein:
the client provides a sort criteria for the at least one queue, wherein the items of the at least one queue are sorted according to the sort criteria, and
the server distributes the item from the at least one queue according to the order in which the items are sorted.

12. The system of claim 9, wherein:
the server assigns a sequential numerical value to each item in the at least one queue,
the server generates a random number that is within the assigned sequence of numerical values, and
the server distributes the item in the at least one queue which corresponds to the generated random number.

13. The system of claim 9, wherein:
the server:
creates a queue reference list that provides an ordered prioritization of two or more queues,
selects a queue to distribute an item from according to the queue reference list, and
distributes an item in the selected queue.

14. The system of claim 9, wherein:
the client is a web client,
the server is a web server, and
the client provides the search criteria input, which is received by the server, via the Internet.

15. The system of claim 9, further comprising:
one among the client and server defining a distribution protocol, and
distributing the item according to the distribution protocol.

16. An apparatus for distributing items, the apparatus comprising:
a memory unit which stores a library of items,
an input unit which receives a search criteria for at least one queue,
a processing unit which searches the library of items for at least one item matching the search criteria, generates a list of search results based on the search, creates the at least one queue by automatically populating the at least one queue with the list of search results, and
an output unit which distributes an item from the at least one queue.

17. The apparatus of claim 16, wherein:
the processing unit updates the at least one queue according to the search criteria when the library of items is modified,
wherein when a new item that matches the search criteria is added to the library of items, the processor adds the item to the at least one queue,
wherein when an item in the library of items is modified and no longer matches the search criteria, the processor removes the item from the at least one queue, and
wherein when an item is removed from the library of items, the processor removes the item from the at least one queue.

18. The apparatus of claim 16, wherein:
the input unit receives sort criteria for the at least one queue, wherein the items of the at least one queue are sorted according to the sort criteria, and
the output unit distributes items from the at least one queue according to the order in which the items are sorted.

19. The apparatus of claim 16, wherein:
the processor:
assigns a sequential numerical value to each item in the at least one queue,
generates a random number that is within the assigned sequence of numerical values, and
the output unit distributes the item in the at least one queue which corresponds to the generated random number.

20. The apparatus of claim 16, wherein:
the processor creates a queue reference list that provides an ordered prioritization of two or more queues,
the output unit selects a queue to distribute an item from according to the queue reference list, and
the output unit distributes an item in the selected queue.
